(19) United States
(12) Patent Application Publication
(10) Pub. No.: US 2002/0042870 A1
(43) Pub. Date: Apr. 11, 2002

(54) System and method for implementing a redundant data storage architecture

(76) Inventors: Claude Rocray, Candiac (CA); Giovanni Chiazzese, Pierrefonds (CA)

Correspondence Address: Jones, Day, Reavis and Pogue, North Point, 901 Lakeside Avenue, Cleveland, OH, 44114, US

(21) Appl. No.: 09/921,835

(22) Filed: Aug. 3, 2001

Related U.S. Application Data
(60) Provisional application No. 60/223,030, filed on Aug. 4, 2000.
(60) Provisional application No. 60/223,080, filed on Aug. 4, 2000.

(51) Int. Cl. G06F 15/80

(52) U.S. Cl. 712/10

(57) ABSTRACT

A system and method for implementing a redundant data storage architecture. In accordance with one aspect of the claimed invention, the system includes a multiprocessor system comprising a plurality of processor modules, and a non-volatile storage memory configuration (NVS). The plurality of processor modules include a software management processor that is coupled to the NVS. The multiprocessor system also comprises a means for uploading and downloading system software and data between the processor modules and the NVS, whereby only the software management processor has read or write access to the NVS. In accordance with another aspect of the claimed invention, the method for implementing a redundant data storage architecture includes managing system software in a multiprocessor system having a plurality of processor modules and a plurality of non-volatile storage devices. A redundant copy of the system software is stored in each non-volatile storage device, and read and write access to the plurality of non-volatile storage devices is restricted to a software management processor. The system software is then loaded to the plurality of processor modules by retrieving the system software with the software management processor, and then loading the system software through the software management processor to the plurality of processor modules.

### CROSS-REFERENCE TO RELATED APPLICATION

This application claims priority from and is related to the following prior applications: U.S. Provisional Application No. 60/223,030, entitled “Redundant Data Storage Architecture” and filed on Aug. 4, 2000; and U.S. Provisional Application No. 60/223,080, entitled “Self-Activating Embedded Application” and filed on Aug. 4, 2000. These prior applications, including the entire written descriptions and drawing figures, are hereby incorporated into the present application by reference.

### TECHNICAL FIELD

The present invention relates in general to multiprocessor system architecture and, more particularly, to non-volatile storage architecture in a multiprocessor environment.

### BACKGROUND

The use of multiple CPUs in a single system is well-known in the field of data processing systems resulting in “multiprocessor” systems. Multiprocessor systems create new challenges for shared memory access. There is a need for a multiprocessor system architecture in which important system data and software may be stored in a protected manner. There is a more particular need for a system in which the system software and data may be stored in a centralized location in a protected manner.

### SUMMARY

Provided is a system and method for implementing a redundant data storage architecture that can be used in a multiprocessor system. The multiprocessor system provides a protected mechanism for accessing and downloading system software and data to the data storage architecture. In accordance with one aspect of the claimed invention, the multiprocessor system comprises a plurality of processor modules, and a non-volatile storage memory configuration (NVS). The plurality of processor modules include a software management processor that is coupled to the NVS. The multiprocessor system also comprises a means for uploading and downloading system software and data between the processor modules and the NVS, whereby only the software management processor has read or write access to the NVS.

In accordance with another aspect of the claimed invention, a method is provided for managing system software in a multiprocessor system having a plurality of processor modules and a plurality of non-volatile storage devices. A copy of the system software is stored in each non-volatile storage device, and read and write access to the plurality of non-volatile storage devices is restricted to a software management processor. The system software is then loaded to the plurality of processor modules by retrieving the system software with the software management processor, and then loading the system software through the software management processor to the plurality of processor modules.

### BRIEF DESCRIPTION OF THE DRAWINGS

The present invention will become more apparent from the following description when read in conjunction with the accompanying drawings wherein:

FIG. 1 is a block diagram of an exemplary multiprocessor system that utilizes a preferred embodiment of the redundant data storage architecture;

FIG. 2 is a front view of an exemplary backplane based multiprocessor system;

FIG. 3 is a schematic view of an exemplary backplane based multiprocessor system;

FIG. 4 is a block diagram showing exemplary functions of a preferred Software Version Management Module (SVM);

FIG. 5 is a block diagram of an exemplary file arrangement for a preferred non-volatile storage memory configuration;

FIG. 6 is a state diagram demonstrating the operation of an exemplary non-volatile storage (NVS) redundancy software module (RSM) utilized by the SVM;

FIG. 7 is a flow diagram of an exemplary method of switching the current and alternate context areas of the Flash File System (FFS);

FIG. 8 is a flow diagram of an exemplary initialization sequence for a multiprocessor system implementing the present invention; and

FIG. 9 is a block diagram of an exemplary communication system in which the present invention is applicable.

### DESCRIPTION OF EXAMPLES OF THE CLAIMED INVENTION

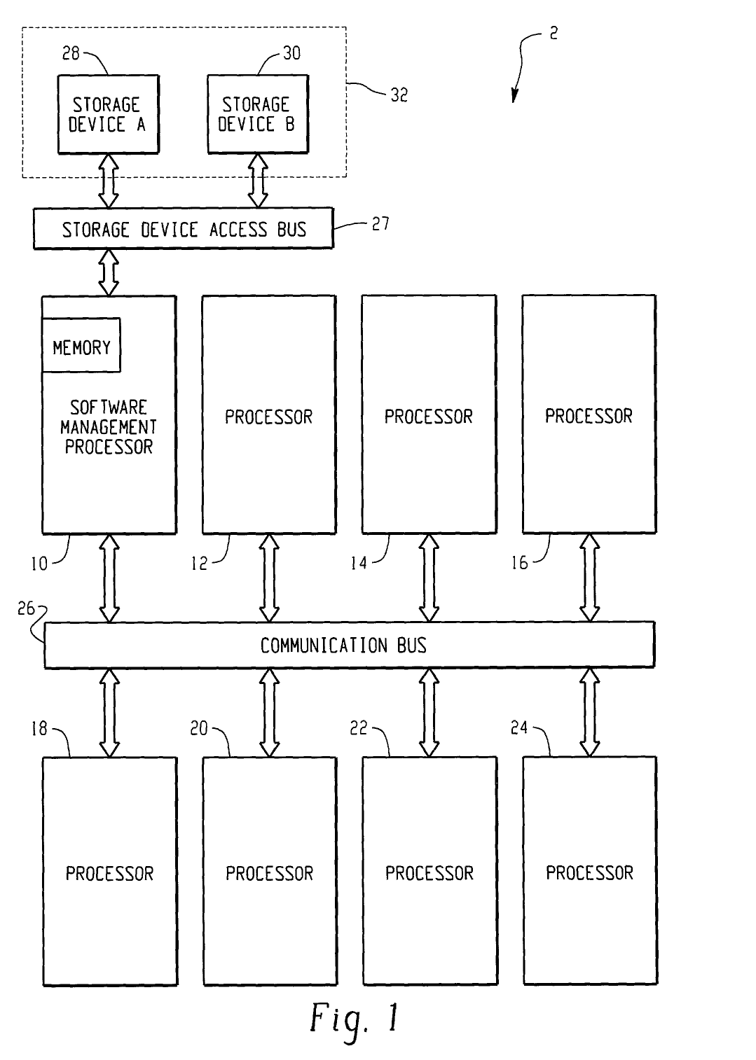

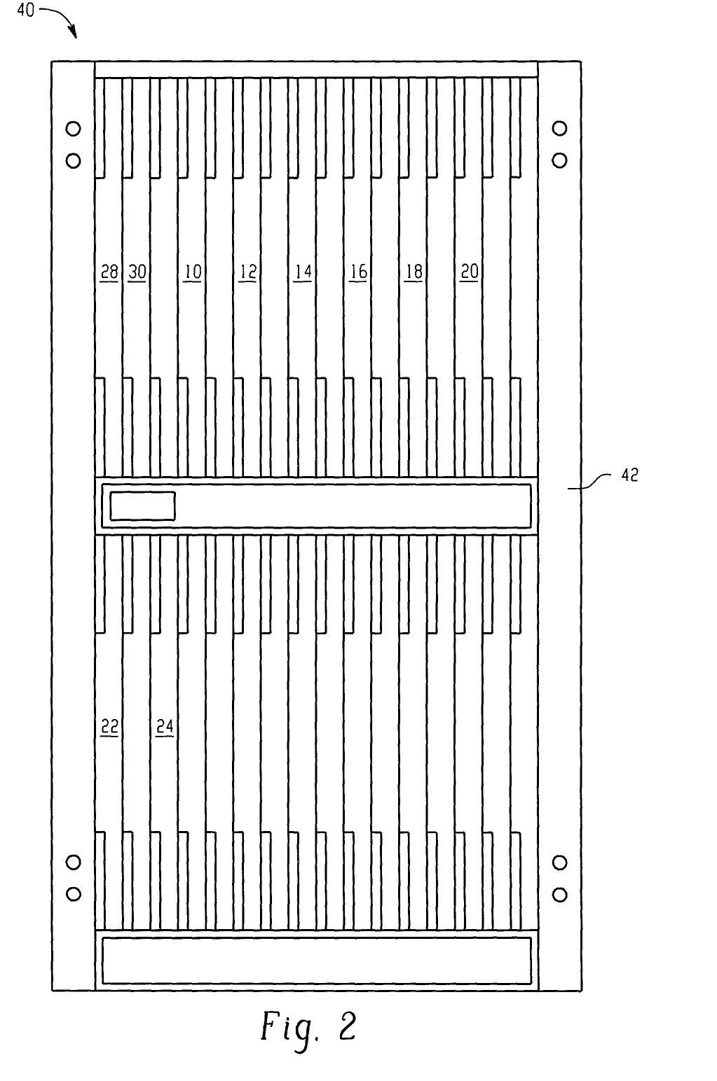

Referring now to the drawing figures, FIG. 1 is a block diagram of an exemplary multiprocessor system 2 that utilizes a preferred embodiment of the redundant data storage architecture according to the present invention. This multiprocessor system 2 protects against data corruption by utilizing a software management processor 10 that has exclusive access to a redundant memory configuration 32. The exemplary multiprocessor system 2 includes a plurality of processor modules 10, 12, 14, 16, 18, 20, 22, and 24 that are coupled together via a communication bus 26. The exemplary multiprocessor system 2 also includes two redundant storage devices—storage device A 28 and storage device B 30 which collectively form a non-volatile storage memory configuration (NVS) 32. In the preferred embodiment, storage device A 28 and storage device B 30 are non-volatile memory cards containing non-volatile memory devices, but, alternatively could be other forms of non-volatile devices such as disk drives, cd drives, and others. Operationally, the NVS is only accessible via a storage device access bus 27 by one processor module—the software management processor 10. The other processor modules 12, 14, 16, 18, 20, and 22 do not have permanent storage and rely on the software management processor 10 to retrieve their software.

The communication bus 26 and storage device access bus 27 could be any number of standard buses such as VME, or, alternatively, they could be proprietary communication buses such as buses that implements the Ethernet protocol over a backplane.

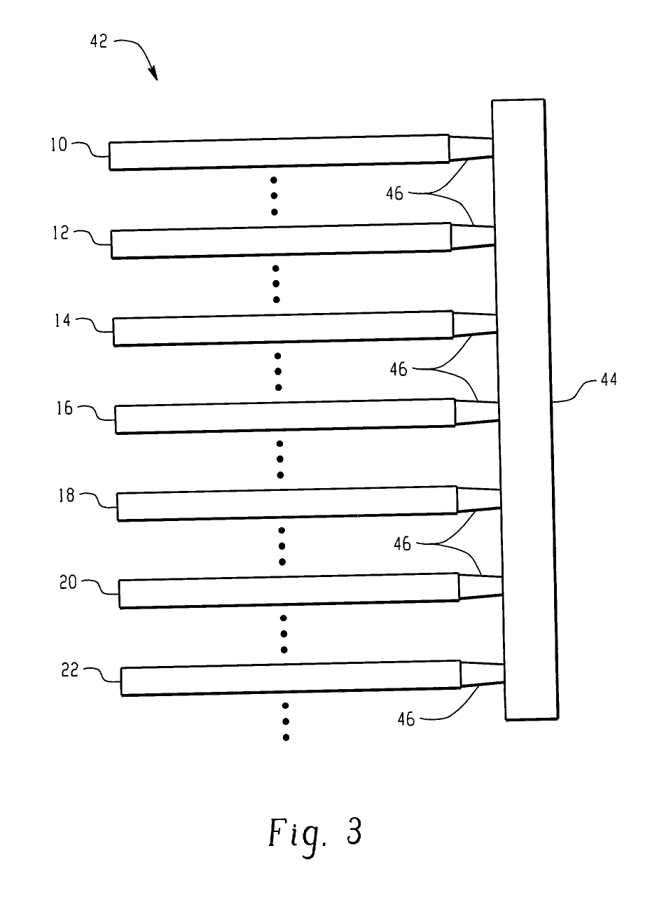

As shown in FIG. 2, one embodiment of the exemplary multiprocessing system 2 includes a backplane based system 40 in which the processors modules 10, 12, 14, 16, 18, 20, 22, and 24, and two redundant storage devices 28 and 30 are mounted in a shelf 42. As shown in FIG. 3, the shelf 42 may contain a backplane 44 which provides a physical media for allowing the processors 10, 12, 14, 16, 18, 20, and 22 to communicate with each other. Each processor 10, 12, 14, 16, 18, 20, and 22 may also include a connector 46 for providing electrical communication pathways between the backplane 44 and components on the processors 10, 12, 14, 16, 18, 20, and 22.

The preferred multiprocessor system 2 preferably includes a system level storage mechanism which includes a software version management module 50 (SVM) and the NVS 32. As described in more detail below, the SVM and the NVS are used cooperatively for storing and managing all of the system level software in the multiprocessor system 2; such as application software, application data, and FPGA programming information used by the various processor modules in the system. In particular, the SVM 50 manages the manner in which system software is updated and stored on the NVS 32 to ensure that software is not lost through the corruption of all copies of the data.

To protect against data corruption, the storage mechanism provides, at any given moment, up to four copies of the system software: a current and alternate copy located in each of the two redundant storage devices 28 and 30. At system power up, the software management processor 10 first retrieves its current version of system software (determined by a boot code) from one of the redundant storage devices 28 or 30. Then, the other processor modules in the system each retrieve their current system software through the software management processor 10 which accesses the software from the NVS 32. In a preferred embodiment, the processor modules retrieve their system software from the NVS 32 using a standard DHCP/FTP mechanism operating on the software management processor 10. For example, when the system is initiated, the processor modules may preferably send DHCP requests to a DHCP server operating on the software management processor 10 that determines the file paths necessary to retrieve the applicable software from the NVS 32. Once the necessary file paths have been retrieved, the system software may be retrieved from the NVS 32 by a FTP file server that also operates on the software management processor 10. Similarly, when software is updated, the new version of system software is loaded to one of the redundant storage devices 28 or 30 through the software management processor 10, and is then backed-up in the other redundant storage device 28 or 30.

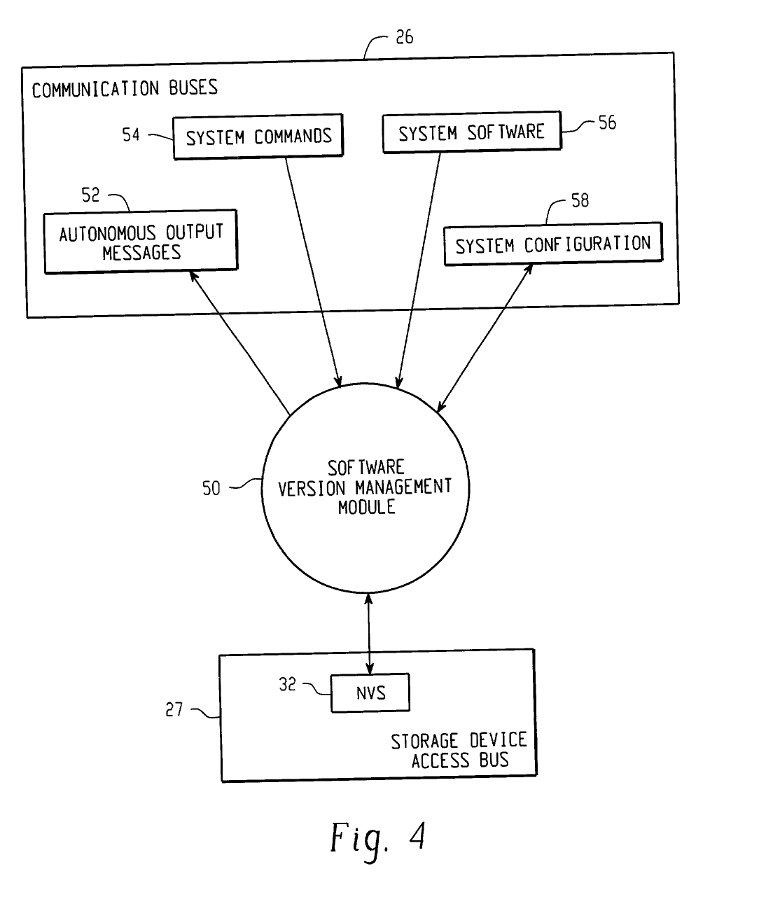

FIG. 4 is a block diagram showing exemplary functions of a preferred SVM 50. A primary function of the SVM 50 is to manage access to the NVS 32. The SVM 50 receives system commands 54 from an operator through the software management processor 10 which trigger software management and maintenance operations. Autonomous output messages 52 regarding these operations and other related conditions may also be generated by the SVM 50 as an indication of its operation or the status of the system 2. In addition, the SVM 50 manages system software downloads 56 to the NVS 32 and system configuration exchanges 58 with the NVS 32.

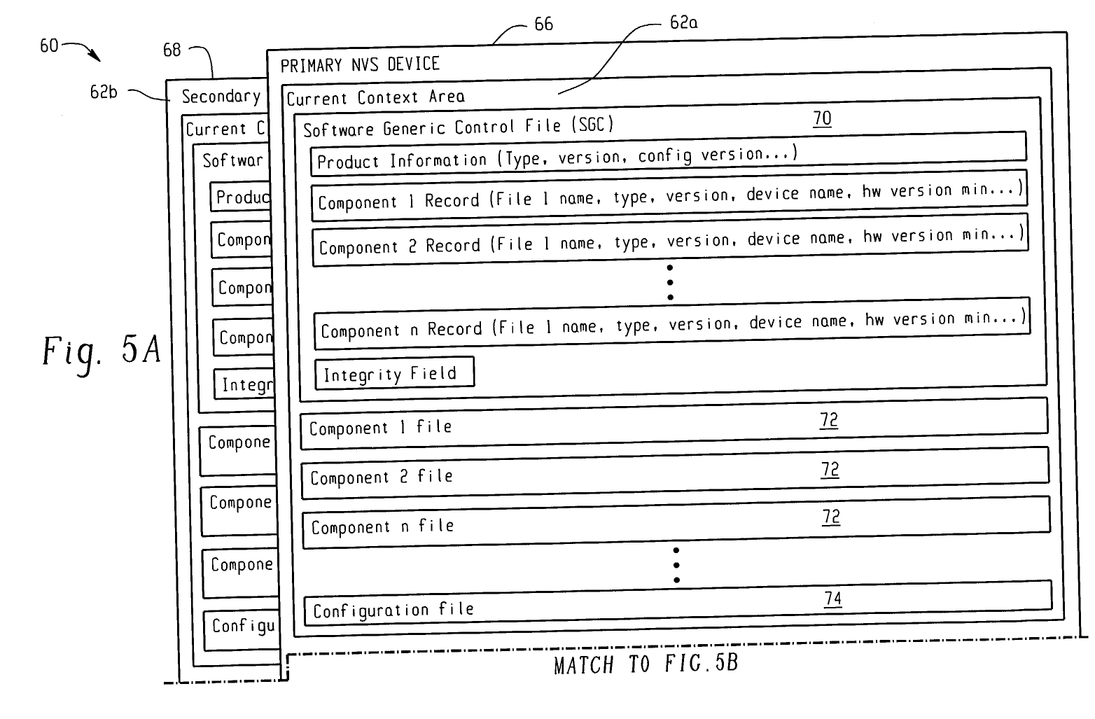

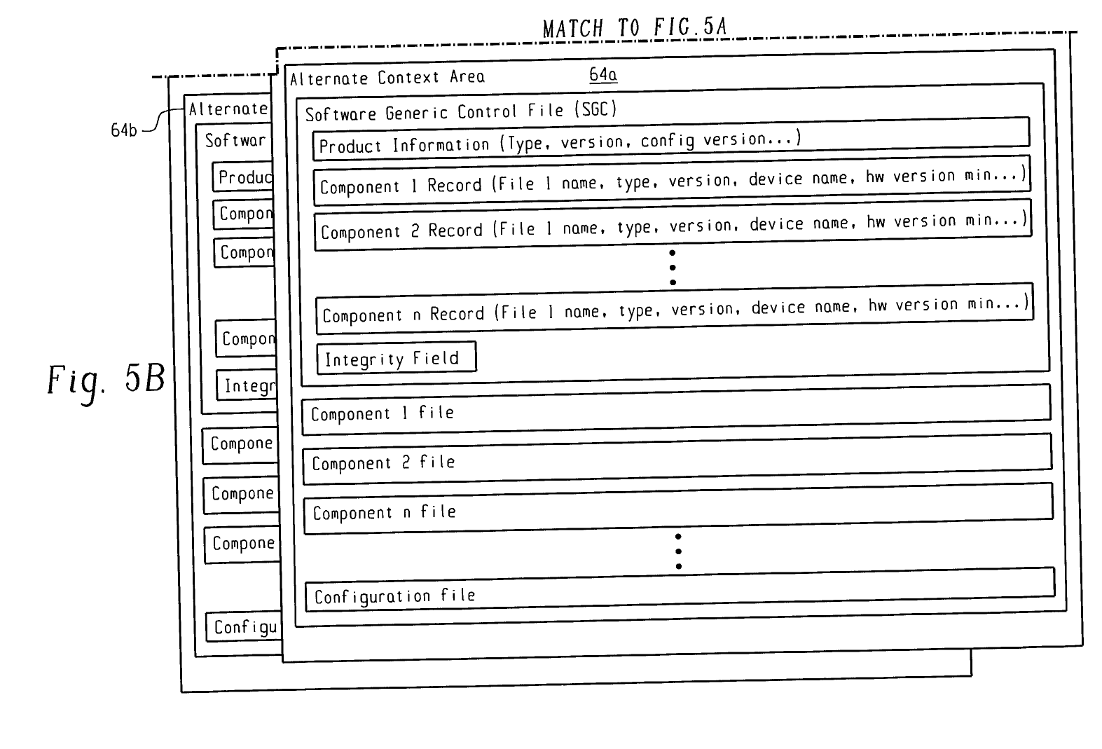

Two exemplary functions which may be executed by the SVM 50 are a general system upgrade and a partial system upgrade. A general system upgrade is performed when an existing shelf 42 running a certain product release level has to be upgraded with new software. The general system upgrade is preferably initiated by triggering the SVM 50 with a system command (such as CPY-MEM) which specifies the file transfer parameters needed to retrieve a package file that identifies the new system files to be downloaded. The new system software files are then retrieved and downloaded to the appropriate files in the alternate context area of the NVS 32. (The alternate and current context areas of the NVS devices are discussed in more detail with reference to FIG. 5.) The general system upgrade is completed by a system wide initialization command (such as ACT-SWVER) which is triggered by the user.

A partial system upgrade is performed when only a portion of the shelf 42 needs to be upgraded with new software (or hardware). In a partial upgrade, the SVM 50 preferably first retrieves an updated software generic control (SGC) file and compares it with a current SGC file to determine which system software files are to be updated. The SVM 50 then retrieves the appropriate new software files and downloads them to the alternate context area of the NVS 32. With respect to those system files that are to remain unchanged, the SVM 50 preferably copies the current version of the files from the current context area to the alternate context area. The partial upgrade is completed by an initialization command (such as ACT-SWVER) initiated by the user.

In the event that some cards need modifications to a programmable device, such as a FPGA (permanent or RAM based), which cannot be directly updated by the SVM 50 during a general or partial upgrade, then the SVM 50 generates an alarm condition and an autonomous output message 52. The system operator may then make the appropriate upgrades to the programmable device. It should be understood, however, that this is just one example of many possible autonomous output messages 52 that may be generated by the SVM 50.

Another aspect of the current invention is apparent when the multiprocessor system 2 is configured as a network element (NE). In a network environment, general and partial system upgrades may be performed either locally or remotely by transferring system files from NE to NE. This function may be performed using standard file transfer mechanisms associated with a known communication stack such as TCP/IP or OSI. In this manner, downloads may be performed remotely to or from any NE that is accessible on the network.

In a preferred embodiment, the SVM 50 is also responsible for automatically saving the RAM configuration to the NVS 32. Preferably, if a user makes any modification to the RAM provisioning data, then a delay is started (or restarted) after which the RAM configuration is saved to the NVS 32. In addition to protecting against data corruption, this function also guarantees that the RAM and NVS configurations are synchronized during a scheduled software management processor 10 shutdown. In the event that no RAM configuration is found in the appropriate software context file (during a software upgrade), then the alternate context in the NVS 32 is checked for a back-up set of configuration files. This situation may occur, for example, if a new RAM configuration is not saved because the software management processor 10 is inappropriately reset. If the back-up configuration files exists, then its associated version number is checked. If the version number is equal to or less than the version supported by the applicable software and within its range of upgrade capability, then the file is used and, if required, upgraded to the appropriate version level. If the version number is greater than the version supported by the software, then the software upgrade is rejected and the system preferably reverts to the selected system software context prior to the upgrade command (ACT-SWVER). Alternatively, the user may have the option to override this protection and force the processor RAM to assume a factory default configuration. To preserve the integrity of RAM configuration files saved on the NVS 32, one embodiment of the present invention also includes a software module present in the SVM 50 that prevents involuntary configuration file manipulation.

The SVM 50 may also perform the function of validating the integrity of the configuration file and software component files stored in the NVS 32. This function is performed using checksums which are stored in the SGC or other control files. The SVM 50 validates the files by ensuring that the checksums in the SGC correspond

FIG. 5 is a block diagram of an exemplary file arrangement 60 for a preferred NVS memory configuration 32. The NVS 32 is managed as a file system referred to herein as a Flash File System (FFS). The exemplary file arrangement 60 includes two storage devices 28 and 30. Each storage device 28 and 30 is preferably designated as either a primary NVS device 66 or a secondary NVS device 68. The primary and secondary designations, however, do not have a permanent relationship with a specific NVS device 28 or 30. Rather, either NVS device 28 or 30 may become the primary NVS device 66 when assigned an active status by the SVM 50. The FFS in each NVS device 66 and 68 is duplicated for redundancy purposes, and includes a current context area 62a and 62b and an alternate context area 64a and 64b. As a result, four complete system context areas co-exist on each system 2 having two NVS devices 66 and 68.

Each context area 62a, 62b, 64a, and 64b within the FFS includes a Software Generic Control file 70, one or more component files 72, and one or more configuration file 74. The component files 72 contain the software or data files needed by each processor to perform its functionality. The SGC 70 contains data used (a) to match software releases with the hardware in the system and with other software releases, and (b) to validate the software and data files to ensure that current versions are in use and to detect data corruption. The configuration file 74 contains data shared by all software components running in the system 2. The Software Generic Control file 70 is described in more detail in the commonly assigned, and copending U.S. Patent Application Ser. No. 09/______ entitled “System And Method For Implementing A Self-Activated Embedded Application,” which is incorporated herein by reference.

Operationally, multiprocessor system 2 protects against data corruption by never allowing data to be written simultaneously to the FFS in both the primary and secondary NVS devices 66 and 68, and by serializing access to the NVS devices 66 and 68 such that only one process or application has write access to the FFS at any given time. This function is performed by the SVM 50 which treats each context area 62a, 62b, 64a, and 64b independently, and synchronizes access to the FFS in the primary and secondary NVS devices 66 and 68. Software or data is downloaded from the software management processor 10 to the alternate context area 64a within the primary NVS device 66. Once the SVM 50 verifies that the download to the primary NVS device 66 is complete and successful, the alternate context area 64a is locked and the alternate context area 64b within the secondary NVS device 68 is unlocked. The software or data in the alternate context area 64a is then copied to the alternate context area 64b. After the backup copy has been made, the locks are reversed back to their original setting.

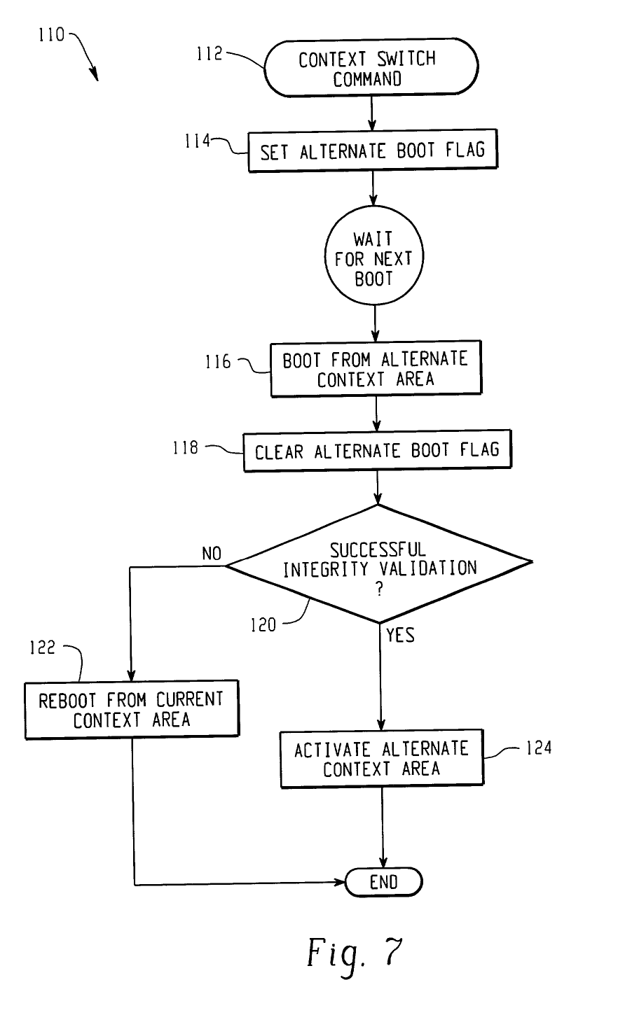

The current context areas 62a and 62b are used by the SVM 50 to upload software or data to the software management processor 10, and through the software management processor 10 to the other processor modules in the system. If the user wishes to re-initialize the system using the software or data downloaded to the alternate context area 64a, then a context switch command is executed. The context switch command, described in detail below with respect to FIG. 7, swaps the alternate and current context area designations.

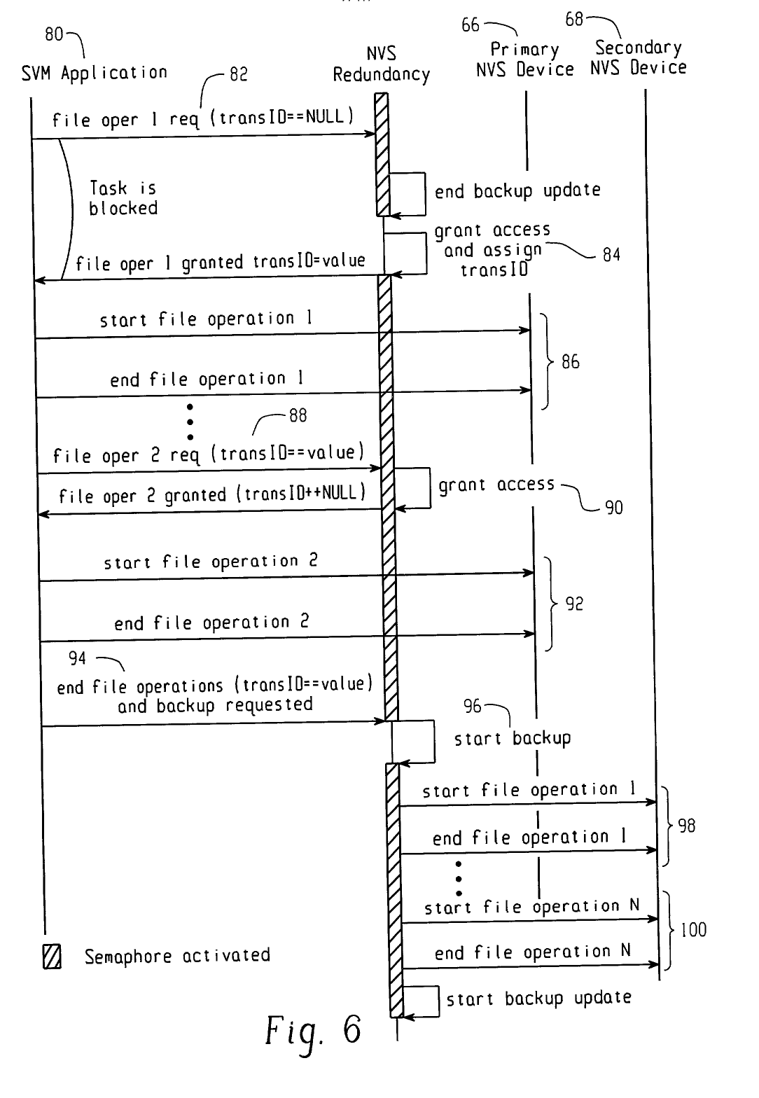

FIG. 6 is a state diagram demonstrating the operation of an exemplary NVS redundancy software module (RSM) utilized by the SVM 50. This software module synchronizes access to the primary and secondary NVS devices 66 and 68, and is the only module permitted write access to the secondary NVS device 68. Operationally, the RSM uses semaphores to ensure that only one NVS device 66 or 68 is accessed at any given time. This operation is demonstrated by the steps 82, 84, 86, 88, 90, 92, 94, 96, 98, and 100 shown in FIG. 6.

In step 82, an SVM application 80 requests a first file operation (file oper 1) while a semaphore is active, indicating that a previous file operation has not yet been completed in the applicable context area. At this point, the RSM blocks access to the NVS until the previous file operation is complete. In step 84, the RSM grants access to the primary NVS device 66 and assigns a transaction ID (transID=value). Control of the semaphore is then passed to the SVM application 80, and the semaphore is activated to deny access to all other applications. During step 86, the SVM application 80 accesses the applicable context area in the primary NVS device 66.

Once a transaction ID has been assigned, the RSM allows an application to request multiple file operations using the same transaction ID. In step 88, the SVM application 80 requests a second file operation (file oper 2) using the transaction ID assigned in step 84. Access to the primary NVS device is granted in step 90, and the second file operation is performed in step 92. Once completed, the SVM application 80 sends a command to the RSM in step 94, indicating that file operations are complete and requesting a backup to the secondary NVS device 68. The RSM then restricts access to the primary NVS device, grants access to the secondary NVS device, and performs a backup in steps 96, 98 and 100. When the backup is complete, the RSM deactivates the semaphore, and access is available to other applications.

FIG. 7 is a flow diagram 110 of an exemplary method of switching the current and alternate context areas of the FFS. This method can be initiated, for example, by a user after a new software version has been downloaded into the alternate context areas 64a and 64b as described above with respect to FIG. 5. Step 112 in the flow diagram 110 is a context switch command entered by the user and executed by the SVM 50. Following the context switch command, an alternate boot flag is set in the RAM on the software management processor 10 (step 114) which instructs the processor 10 to boot from the alternate context area 64a the next time it is initialized (step 116). This is a one-time occurrence. Once the processor 10 has booted from the alternate context area 64a, the alternate boot flag is cleared (step 118), and the processor 10 will again boot from the current context area 62a.

After the processor 10 has booted from the alternate context area 64a, the SVM 50 performs an integrity validation to ensure that the new software version has loaded and is running correctly, and to verify the integrity of the context area in which the software is loaded (step 120). If any problems are detected by the SVM 50, the context switch is abandoned, and the processor 10 reboots from the previous software version stored in the current context area 62a (step 122). Consequently, the present invention does not allow continued rebooting from a context area unless it has been proven that the context area can be successfully booted from.

In the last step 124, the alternate context areas 64a and 64b containing the new software version are activated by the SVM 50, which redesignates them as current context areas. Therefore, when the processor 10 is next initialized, it will boot from the new software version in the newly activated current context area.

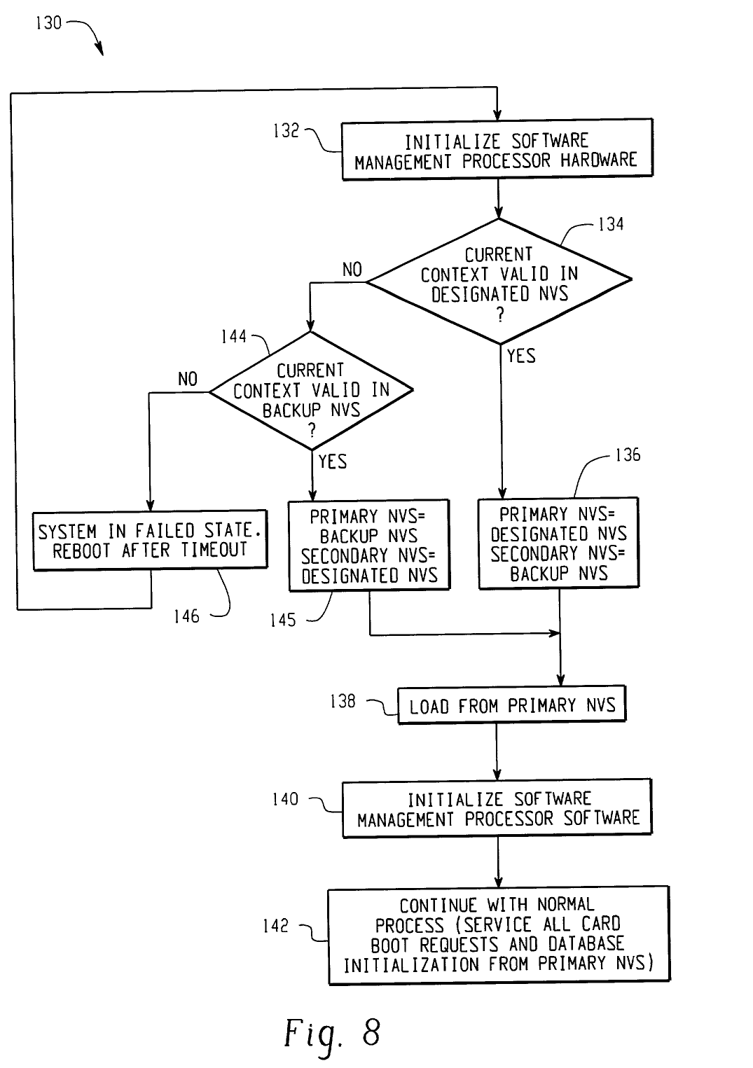

FIG. 8 is a flow diagram 130 of an exemplary initialization sequence for a multiprocessor system implementing the present invention. This initialization sequence 130 incorporates a mechanism to avoid booting from a failing context area. Upon receiving an initialization command from the hardware of the software management processor 10 (step 132), the SVM 50 verifies the integrity of the system software stored in the current context area within a designated NVS device (step 134). If the software is valid, the SVM 50 assigns the designated NVS device as the primary NVS device 66, and assigns a redundant backup NVS device as the secondary NVS device 68 (step 136). The system 2 is then initialized using software loaded from the primary NVS device 66 (steps 138, 140, and 142).

If the designated NVS device is corrupt, however, the SVM 50 performs an integrity check on the backup copy of the system software which is stored in the current context within a backup NVS device (step 144). Then, if the backup copy of the software is valid, the backup NVS device is assigned as the primary NVS device 66 (step 145), and the system 2 is initialized using this alternate copy of the software (steps 138, 140, and 142).

If both the designated and backup NVS devices contain corrupt data, then the system initiation sequence preferably waits for the insertion of a new NVS device containing valid system software, and then reboots (step 146). In an alternative embodiment, valid system software may be loaded from an external computer in the event that both NVS devices contain corrupt data.

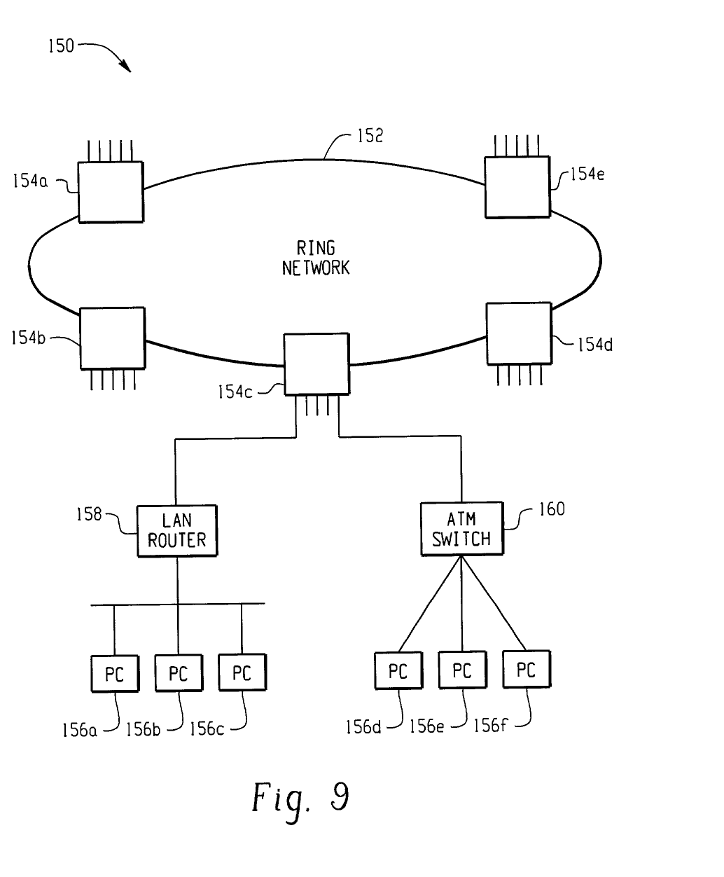

FIG. 9 is a block diagram of an exemplary communication system 150 in which the present invention is applicable. The exemplary communication system 150 is arranged in a ring network 152 and more preferably in a Synchronous Optical Network (“SONET”) or SDH ring. The communication system 150 includes a plurality of multiprocessor systems 154a, 154b, 154c, 154d, and 154e according to the present invention that are configured to operate as network nodes, and are coupled together in the ring network 152. The communication system 150 also includes a plurality of PCs 156a, 156b, 156c, 156d, 156e, and 156f each coupled to the ring network 152 through either a LAN router 158 or an ATM switch 160.

Operationally, the processor modules in each node 154a, 154b, 154c, 154d, and 154e act as either traffic carrying modules, i.e., modules that carry IP or ATM traffic to or from the node, or cross-connect modules, i.e., modules that pass IP or ATM traffic from one traffic carrying module to another traffic carrying module. The communication paths between each node 154a, 154b, 154c, 154d, and 154e are preferably fiber optic connections (in SONET/SDH), but could, alternatively be electrical paths or even wireless connections.

The embodiments described herein are examples of structures, systems or methods having elements corresponding to the elements of the invention recited in the claims. This written description may enable those skilled in the art to make and use embodiments having alternative elements that likewise correspond to the elements of the invention recited in the claims. The intended scope of the invention thus includes other structures, systems or methods that do not differ from the literal language of the claims, and further includes other structures, systems or methods with insubstantial differences form the literal language of the claims.

We claim:

1. A multiprocessor system, comprising:
a plurality of processor modules, including a software management processor;
a non-volatile storage memory configuration (NVS) coupled to the software management processor; and
means for uploading and downloading system software and data between the processor modules and the NVS, whereby only the software management processor has read or write access to the NVS.

2. The multiprocessor system of claim 1, wherein a software mechanism operates on the software management processor to control the transfer of software or data between the NVS and the processor modules.

3. The multiprocessor system of claim 2, wherein the software mechanism comprises a DHCP server.

4. The multiprocessor system of claim 2, wherein the software mechanism comprises an FTP server.

5. The multiprocessor system of claim 1, wherein the NVS is coupled to the software management processor by a dedicated storage device access bus.

6. The multiprocessor system of claim 1, wherein the processor modules are coupled together by a communication bus.

7. The multiprocessor system of claim 6, wherein the processor modules are physically coupled to a backplane that provides the communication bus.

8. The multiprocessor system of claim 1, wherein the NVS comprises two redundant storage devices.

9. The multiprocessor system of claim 8, wherein the two redundant storage devices are non-volatile memory devices.

10. The multiprocessor system of claim 1, wherein the uploading and downloading means is a software version management module (SVM) that is executed by the software management processor and controls read and write access to the NVS.

11. The multiprocessor system of claim 1, wherein the multiprocessor system is configured as a node in a ring network.

12. The multiprocessor system of claim 11, wherein the ring network is a synchronous optical network.

13. The multiprocessor system of claim 11, wherein the processor modules operate as either traffic carrying modules or cross-connect modules for the ring network.

14. A multiprocessor system, comprising:
a plurality of processor modules including a software management processor;
a non-volatile storage memory configuration (NVS) coupled to the software management processor, and having a plurality of redundant storage devices that store redundant copies of system software; and
a software version management module (SVM) executed by the software management processor, that manages the system software stored in the NVS, controls read and write access between the NVS and the software management processor, and enables system software to be loaded from the software management processor to the processor modules.

15. The multiprocessor system of claim 14, wherein the SVM prevents the redundant storage devices from being accessed simultaneously.

16. The multiprocessor system of claim 14, wherein each redundant storage device has a file system comprising:
a current context area containing a copy of system software that is accessible to the SVM for upload to the processor modules; and
an alternate context area that is accessible to the SVM for downloading a different version of system software.

17. The multiprocessor system of claim 16, wherein the alternate context area and current context area in each redundant storage device may be switched, whereby system software in the alternate context area becomes accessible to the SVM for upload to the software management processor.

18. The multiprocessor system of claim 17, wherein the alternate context area and current context area in each redundant storage device are switched by the SVM at system initialization.

19. The multiprocessor system of claim 16, wherein the current and alternate context areas in each redundant storage device include a plurality of component files that store system software components needed for the processor modules to perform their functionality.

20. The multiprocessor system of claim 19, wherein the current and alternate context areas in each redundant storage device further include a software generic control (SGC) file that stores data used to match the system software components with one or more of the processor modules.

21. The multiprocessor system of claim 20, wherein a checksum is associated with each system software component, and the SVM uses the checksums to validate the integrity of the system software.

22. The multiprocessor system of claim 21, wherein the checksum is stored in the software generic control file.

23. The multiprocessor system of claim 16, wherein the current and alternate context areas in each redundant storage device include a configuration file.

24. The multiprocessor system of claim 23, wherein a checksum is associated with each configuration file, and the SVM uses the checksum to validate the integrity of the configuration file.

25. The multiprocessor system of claim 14, wherein the NVS comprises a primary NVS device and a secondary NVS device that respectively store a designated and backup copy of the system software.

26. The multiprocessor system of claim 25, wherein the primary NVS device and secondary NVS device designations do not have a permanent relationship with a specific redundant storage device, and may be assigned new designations by the SVM.

27. The multiprocessor system of claim 25, wherein the system software is organized in a flash file system comprising:
a primary current context area in the primary NVS device that stores the designated copy of system software which is accessible to the SVM for upload to the processor modules through the software management processor;
a secondary current context area in the secondary NVS device that stores the backup copy of system software which is accessible to the SVM for upload to the processor modules through the software management processor;
a primary alternate context area in the primary NVS device that is accessible to the SVM for downloading a different version of system software; and
a secondary alternate context area in the second primary NVS device that is accessible to the SVM to backup the different version of system software.

28. A communication system, comprising:
a plurality of multiprocessor systems coupled in a ring network, and comprising,
a plurality of processor modules coupled together that operate in the ring network as either traffic carrying modules or cross-connect modules,
a software management processor,
a non-volatile storage memory configuration (NVS) coupled to the software management processor, and having a plurality of redundant storage devices that store redundant copies of system software, and
a software version management module (SVM) executed by the software management processor, that manages the system software stored in the NVS, controls read and write access between the NVS and the software management processor, and enables system software to be loaded from the software management processor to the processor modules; and
a plurality of personal computers coupled to each multiprocessor system in the ring network.

29. The communication system of claim 28, wherein the plurality of personal computers are coupled to each multiprocessor system through a LAN router.

30. The communication system of claim 28, wherein the plurality of personal computers are coupled to each multiprocessor system through an ATM switch.

31. The communication system of claim 28, wherein a portion of the plurality of personal computers are coupled to each multiprocessor system through a LAN router, and another portion of the plurality of personal computers are coupled to each multiprocessor system through an ATM switch.

32. The communication system of claim 28, wherein the ring network is a synchronous optical network.

33. A method of managing system software in a multiprocessor system having a plurality of processor modules and a plurality of non-volatile storage devices, comprising the steps of:
storing a redundant copy of the system software in each non-volatile storage device;
restricting read and write access to the plurality of non-volatile storage devices to a software management processor that is coupled to the plurality of processor modules; and
loading the system software to the plurality of processor modules by retrieving the system software with the software management processor, and then loading the system software through the software management processor to the plurality of processor modules.

34. The method of claim 33, wherein a new version of system software may be stored in the plurality of non-volatile storage devices by the additional steps of:
downloading the new version of system software from the software management processor to one of the non-volatile storage devices; and
copying the new version of system software to each additional non-volatile storage device.

35. The method of claim 33, wherein the plurality of redundant storage devices comprise a primary NVS device and a secondary NVS device that respectively store a designated and a backup copy of the system software.

36. The method of claim 34, wherein the new version of system software is downloaded to a primary NVS device, and copied from the primary NVS device to a secondary NVS device.

37. The method of claim 36, wherein access to the primary NVS device is restricted while the new version of system software is being copied to the secondary NVS device.

38. The method of claim 35, wherein the primary and secondary NVS devices each include a current context area and an alternate context area, and the system software is loaded to the software management processor from the current context area.

39. A method of performing a system upgrade in a multiprocessor system having a primary non-volatile storage (NVS) devices, a secondary NVS device and a plurality of processor modules, comprising the steps of:
identifying component files in the primary NVS device that store system software components used by the multiprocessor system;
downloading a new version of system software through a software management processor to the identified component files in the primary NVS device;
creating a backup copy of the new version of system software in a secondary NVS device by copying the identified component files from the primary NVS device;
loading the new version of system software from the primary NVS device to the plurality of processor modules through the software management processor.

40. The method of claim 39, wherein the new version of system software is downloaded through the software management processor using an FTP server operating on the software management processor.

41. The method of claim 39, wherein the new version of system software is downloaded through the software management processor using an FTAM server operating on the software management processor.

42. The method of claim 39, wherein the step of identifying component files in the primary NVS device that store system software components used by the multiprocessor system is performed by receiving a package file at the software management processor that includes a list of the component files to be upgraded.

43. The method of claim 42, comprising the additional step of:
receiving a system command at the software management processor that includes file transfer parameters necessary to retrieve the package file.

44. The method of claim 39, wherein the step of loading the new version of system software from the primary NVS device to the software management processor is preceded by the step of:
initiating a system wide initialization command.

45. The method of claim 39, comprising the additional step of:
generating an autonomous output message if the system upgrade requires modifications to a programmable device on any processor module.

46. The method of claim 39, wherein the multiprocessor system is configured as a node in a ring network, and the system upgrade is performed remotely.

47. A method of performing a partial system upgrade in a multiprocessor system having a non-volatile storage memory configuration (NVS) and a plurality of processor modules, comprising the steps of:
identifying component files in a primary NVS device that store system software components used by the processor modules to be upgraded;
downloading a new version of system software through a software management processor to the identified component files in the primary NVS device;
creating a backup copy of the new version of system software in a secondary NVS device by copying the identified component files from the primary NVS device;
loading the new version of system software from the primary NVS device to the plurality of processor module through the software management processor.

48. The method of claim 47, wherein the step of loading the new version of system software is preceded by the additional step of:
copying any component files other than the identified component files from the primary NVS device to the secondary NVS device.

49. The method of claim 47, wherein the component files in the primary NVS device are identified by the steps of:
receiving a new software generic control (SGC) file; and
comparing the new SGC file with a previous SGC file stored on the NVS.

50. The method of claim 47, wherein the step of loading the new version of system software from the primary NVS device to the software management processor is preceded by the step of:
initiating an initialization command that acts only on the processor modules to be upgraded.

51. The method of claim 47, comprising the additional step of:
generating an autonomous output message if the partial system upgrade requires modifications to a programmable device on any processor module.

52. The method of claim 47, wherein the multiprocessor system is configured as a node in a ring network, and the partial system upgrade is performed remotely.

53. A method of managing processor configurations in a multiprocessor system having a non-volatile storage memory configuration (NVS) and a plurality of processor modules, comprising the steps of:
storing a backup configuration in the NVS;
checking for a configuration file in the NVS;
if the configuration file is found in the NVS, then loading the configuration file to the plurality of processor modules through a software management processor;
if the configuration file is not found in the NVS, then determining whether the backup configuration is supported by the multiprocessor system;
if the configuration file is not found in the NVS and the backup configuration is supported by the multiprocessor system, then loading the backup configuration to the plurality of processor modules through a software management processor.

54. The method of claim 53, wherein if the configuration file is not found in the NVS and the backup configuration is not supported by the multiprocessor system, then providing a user with an option to restore a factory default configuration.

55. The method of claim 53, wherein a software version management module automatically stores the backup configuration.

56. The method of claim 53, wherein the step of checking for a configuration file is performed by the software management processor when the multiprocessor system is initialized.

57. A method of synchronizing access to a non-volatile storage memory configuration (NVS) in a multiprocessor system, comprising the steps of:
receiving a file operation request;
checking if a semaphore is active;
if the semaphore is active, then blocking access to the NVS until a previous file operation is complete and the semaphore is deactivated;
if the semaphore is not active, then granting access to a primary NVS device and activating the semaphore;
performing a file operation on the primary NVS device;
restricting access to the primary NVS device and granting access to a secondary NVS device;
performing a backup of the file operation on the secondary NVS device; and
deactivating the semaphore.

58. The method of claim 57, comprising the additional steps of:
assigning a transaction ID when access to the primary NVS device is granted; and
performing additional file operations on the primary NVS device upon receiving additional file operation requests including the transaction ID.

59. The method of claim 57, wherein the step of restricting access to the primary NVS device and granting access to a secondary NVS device is preceded by the step of:
receiving an command indicating that the file operation on the primary NVS device is complete, and requesting access to the secondary NVS device.

60. The method of claim 57, wherein a first semaphore is used to gain read access to a current context area on the primary and secondary NVS devices, and a second semaphore is used to gain write access to an alternate context area on the primary and secondary NVS devices.

61. The method of claim 60, wherein a third semaphore ensures that only one context area is accessed at any given time.

62. A method of activating a new software version in a multiprocessor system having a redundant flash file system (FFS) with a current context area and an alternate context area, comprising the steps of:
loading the new software version in the alternate context area;
receiving a context switch command;
setting an alternate boot flag that instructs the multiprocessor system to load the new software version from the alternate context area upon system initialization;
loading the new software version to the multiprocessor system from the alternate context area upon system initialization;
clearing the alternate boot flag, whereby the multiprocessor system returns to its ordinary state of loading software from the current context area upon system initialization;
validating that the new software has loaded and is functioning properly;
if the new software has not loaded or is not functioning properly, then loading a previous software version to the multiprocessor system from the current context area; and
if the new software has loaded and is functioning properly, then activating the alternate context area, whereby the alternate context area is redesignated as the current context area.

63. The method of claim 62, wherein a designated copy of the FSS is located on a primary NVS device and a backup copy of the FFS is located on a secondary NVS device.

64. The method of claim 62, wherein if the new software has loaded and is functioning properly, then the new software version in the alternate context area is designated as the current context area.

65. A method of initializing a multiprocessor system having a non-volatile storage memory configuration (NVS) and a plurality of processor modules, comprising the steps of:
verifying the integrity of system software stored in a primary NVS device;
if the system software stored in the primary NVS device is valid, then loading the system software from the primary NVS device to a software management processor;
if the system software stored in the primary NVS device is corrupt, then accessing a secondary NVS device and verifying the integrity of a backup copy of system software;
if the secondary NVS device has been accessed and the backup copy of system software is valid, then loading the backup copy of system software from the secondary NVS device to the software management processor;
if the secondary NVS device has been accessed and the backup copy of system software is corrupt, then replacing the primary NVS device and returning to the step of verifying the integrity of system software stored in the primary NVS system; and
loading the system software or backup copy of the system software from the software management processor to the plurality of processor modules.

66. The method of claim 65, wherein if the secondary NVS device has been accessed and the backup copy of system software is corrupt, then downloading a new copy of system software to the primary NVS device and returning to the step of verifying the integrity of system software stored in the primary NVS device.

67. A method of initializing a multiprocessor system having a non-volatile storage memory configuration (NVS) and a plurality of processors, comprising the steps of:
verifying the integrity of system software stored in a designated NVS device;
if the system software stored in the designated NVS device is valid, then assigning the designated NVS device as a primary NVS device;
if the system software stored in the designated NVS device is corrupt, then accessing a backup NVS device and verifying the integrity of a backup copy of system software;
if the backup NVS device has been accessed and the backup copy of system software is valid, then assigning the backup NVS device as the primary NVS device;
if the backup NVS device has been accessed and the backup copy of system software is corrupt, then replacing the designated NVS device and returning to the step of verifying the integrity of system software stored in a designated NVS device;
loading system software from the primary NVS device to a software management processor; and
loading system software from the software management processor to the plurality of processors.

68. The method of claim 67, wherein if the backup NVS device has been accessed and the backup copy of system software is corrupt, then downloading a new copy of system software to the designated NVS device and returning to the step of verifying the integrity of system software in a designated NVS device.

69. The method of claim 67, comprising the additional steps of:
assigning the backup NVS device as a secondary NVS device if the system software stored in the designated NVS device is valid; and
assigning the designated NVS device as the secondary NVS device if the backup NVS device has been accessed and the backup copy of system software is valid.

70. The method of claim 67, wherein the step of verifying the integrity of system software in a designated NVS device is preceded by the step of:
initiating a system wide initialization command on the software management processor.

71. A multiprocessor system, comprising:
a non-volatile storage memory configuration (NVS) having a primary NVS device and a secondary NVS device;
a software management processor having exclusive read and write access to the NVS;
a software version management module (SVM) executed by the software management module that controls read and write access between the NVS and the software management processor;
a primary current context area in the primary NVS device that stores a current copy of system software, and may be accessed by the SVM to upload the current copy of system software to the software management processor;
a secondary current context area in the secondary NVS device that stores a backup copy of system software, and may be accessed by the SVM to upload the backup copy of system software to the software management processor;
a primary alternate context area in the primary NVS device that may be accessed by the SVM to download a new version of system software through the software management processor;
a secondary alternate context area in the secondary NVS device that may be accessed by the SVM to create a backup copy of the new version of system software in the primary alternate context area;
means of exchanging the system software in the primary current context area with the system software in the primary alternate context area, and exchanging the backup system software in the secondary current context area with the backup system software in the secondary alternate context area; and
a plurality of processor modules coupled to the software management processor that retrieve system software from the software management processor.

72. A method of managing system software in a multiprocessor system having a primary and a secondary non-volatile storage (NVS) device and a plurality of processor modules, comprising the steps of:
enabling a user to download a new version of system software from a file server to a primary alternate context area of the primary NVS device, and creating a backup copy of the new version of system software in a secondary alternate context area of the secondary NVS device;
enabling a user to exchange the new version of system software stored in the primary alternate context area with a current version of system software stored in a primary current context area of the primary NVS device, and exchange the backup copy of the new version of system software with a backup copy of the current version of system software stored in a secondary current context area;
uploading the current copy of system software from the primary NVS device to a software management processor upon initialization of the multiprocessor system; and
loading the current copy of system software through the software management processor to the plurality of processor modules.
